(19) United States
(12) Patent Application Publication
(10) Pub. No.: US 2025/0106850 A1
(43) Pub. Date: Mar. 27, 2025

(54) OPTIMIZING TRANSMISSIONS OVER FRONTHAUL NETWORK IN A BASE STATION SYSTEM

(71) Applicant: CommScope Technologies LLC, Claremont, NC (US)

(72) Inventors: Yogesh C.S, Bengaluru (IN); Suresh N. Sriram, Bangalore (IN); Sudarshana Varadappa, Bangalore (IN)

(73) Assignee: CommScope Technologies LLC, Claremont, NC (US)

(21) Appl. No.: 18/899,456

(22) Filed: Sep. 27, 2024

Related U.S. Application Data
(60) Provisional application No. 63/585,795, filed on Sep. 27, 2023.

(51) Int. Cl. H04W 72/1273; H04W 88/08

(52) U.S. Cl. CPC H04W 72/1273; H04W 88/085

(57) ABSTRACT

The present disclosure describes techniques of data transmission over a fronthaul network in a system comprising a baseband unit (BBU) and a plurality of radio units (RUs) communicatively coupled with the BBU over the fronthaul network. In the techniques of the present disclosure, the system generates a plurality of downlink commands corresponding to the plurality of RUs for scheduling a plurality of UEs across the plurality of RUs, where generating the plurality of downlink commands comprises generating a single downlink command per RU of the plurality of RUs. The system transmits the downlink commands towards the plurality of RUs over the fronthaul network and receives a plurality of uplink data packets corresponding to the plurality of downlink commands over the fronthaul network, where receiving the plurality of uplink data packets comprises receiving a single uplink data packet per RU comprising data associated with all UEs served by the RU.

### CROSS-REFERENCE TO RELATED APPLICATIONS

This application claims the benefit of U.S. Provisional Patent Application Ser. No. 63/585,795, filed on Sep.27, 2023, which is hereby incorporated herein by reference in its entirety.

### TECHNICAL FIELD

The present disclosure in general relates to wireless communication systems. More particularly, but not exclusively, the present disclosure relates to methods and systems for optimizing transmissions over a fronthaul network between baseband units and radio units in a base station system.

### BACKGROUND

The term Radio Access Network (RAN) refers to a part of a mobile communication network that connects wireless devices or user equipment (UEs) to a network infrastructure through wireless radio channels. RANs have evolved significantly since the origin of the mobile communication networks. Different generations of mobile communication networks use different types of RANs for implementing base station functionalities. A cloud or centralized radio access network (C-RAN) is one way to implement the base station functionalities in modern mobile communication networks for providing wireless services to UEs.

Typically, a C-RAN implements the base station functionalities using one or more centralized baseband units (BBUs) which are physically separated and communicatively coupled with a plurality of geographically separate radio units (RUS). The C-RAN may be used to implement a plurality of cells and for each cell implemented by the C-RAN, one or more BBUs may be communicatively coupled with one or more RUs via a fronthaul network (also referred to as a “fronthaul interface”) for serving UEs of the cell. The fronthaul network is a critical link that allows exchange of data/information between the baseband units and the radio units. It may be desirable to optimize communications or data transmissions over the fronthaul network to ensure efficient resource utilization and for improving network performance.

The information disclosed in this background section is only for enhancement of understanding of the general background of the disclosure and should not be taken as an acknowledgement or any form of suggestion that this information forms the prior art already known to a person skilled in the art.

### SUMMARY

According to an aspect of the present disclosure, methods, systems, and computer readable media are provided for optimizing transmissions on a fronthaul network between baseband units and radio units in a base station system.

One non-limiting embodiment of the present disclosure is directed to a method of data transmission in a base station system. The base station system comprises a baseband unit (BBU) configured to perform at least some baseband processing, and a plurality of radio units (RUs) communicatively coupled with the BBU over a fronthaul network and configured to wirelessly communicate with a plurality of user equipment (UEs) via a respective set of one or more antennas. The method comprises generating a plurality of downlink commands corresponding to the plurality of RUs for scheduling the plurality of UEs across the plurality of RUs, where generating the plurality of downlink commands comprises generating a single downlink command per RU of the plurality of RUs. The method further comprises transmitting the generated plurality of downlink commands towards the plurality of RUs over the fronthaul network and receiving a plurality of uplink data packets corresponding to the plurality of downlink commands over the fronthaul network, where receiving the plurality of uplink data packets comprises receiving a single uplink data packet per RU comprising data associated with all UEs served by the RU.

Another non-limiting embodiment of the present disclosure is directed to a base station system comprising a baseband unit (BBU) configured to perform at least some baseband processing, and a plurality of radio units (RUs) communicatively coupled with the BBU over a fronthaul network and configured to wirelessly communicate with a plurality of user equipment (UEs) via a respective set of one or more antennas. The base station system is configured to generate a plurality of downlink commands corresponding to the plurality of RUs for scheduling the plurality of UEs across the plurality of RUs, where to generate the plurality of downlink commands, the base station system is configured to generate a single downlink command per RU of the plurality of RUs. The base station system is further configured to transmit the generated plurality of downlink commands towards the plurality of RUs over the fronthaul network and receive a plurality of uplink data packets corresponding to the plurality of downlink commands over the fronthaul network. To receive the plurality of uplink data packets, the base station system is configured to receive a single uplink data packet per RU comprising data associated with all UEs served by the RU.

Another non-limiting embodiment of the present disclosure is directed to a non-transitory computer readable media for data transmission in a base station system comprising a baseband unit (BBU) configured to perform at least some baseband processing, and a plurality of radio units (RUs) communicatively coupled with the BBU over a fronthaul network and configured to wirelessly communicate with a plurality of user equipment (UEs) via a respective set of one or more antennas. The non-transitory computer readable media stores one or more instructions which, when executed by the base station system, cause the base station system to generate a plurality of downlink commands corresponding to the plurality of RUs for scheduling the plurality of UEs across the plurality of RUs, where generating the plurality of downlink commands comprises generating a single downlink command per RU of the plurality of RUs. The instructions further cause the base station system to transmit the generated plurality of downlink commands towards the plurality of RUs over the fronthaul network and receive a plurality of uplink data packets corresponding to the plurality of downlink commands over the fronthaul network, where receiving the plurality of uplink data packets comprises receiving a single uplink data packet per RU comprising data associated with all UEs served by the RU.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Further aspects and advantages of the present disclosure will be readily understood from the following detailed description with reference to the accompanying drawings. Reference numerals have been used to refer to identical or functionally similar elements. The figures together with a detailed description below, are incorporated in and form part of the specification, and serve to further illustrate the embodiments and explain various principles and advantages, in accordance with the present disclosure wherein:

FIG. 1 shows an exemplary block diagram of a radio access network (RAN) communication system 100 in which the techniques of the present disclosure may be implemented, in accordance with some embodiments of the present disclosure.

FIG. 2 shows an exemplary block diagram 200 illustrating downlink C-plane transmissions over a fronthaul network between a DU and multiple RUs in an exemplary RAN deployment.

FIG. 3 shows an exemplary block diagram 300 illustrating uplink data transmissions over a fronthaul network between a DU and multiple RUs in an exemplary RAN deployment.

FIG. 4 shows an exemplary block diagram 400 illustrating downlink C-plane transmissions over a fronthaul network between a DU and multiple RUs in an exemplary RAN deployment, in accordance with some embodiments of the present disclosure.

FIG. 5 shows an exemplary block diagram 500 illustrating uplink data transmissions over a fronthaul network between a DU and multiple RUs in an exemplary RAN deployment, in accordance with some embodiments of the present disclosure.

FIG. 6 shows a high-level block diagram of an apparatus 600 which may implement the techniques consistent with the present disclosure, in accordance with some embodiments of the present disclosure.

FIG. 7 shows a flowchart of an exemplary method 700 of data transmission in a base station system, in accordance with some embodiments of the present disclosure.

It should be appreciated by those skilled in the art that any block diagrams herein represent conceptual views of the illustrative systems embodying the principles of the present disclosure. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present disclosure described herein as “exemplary” is not necessarily to be construed as preferred or advantageous over other embodiments.

While the disclosure is susceptible to various modifications and alternative forms, specific embodiments thereof have been shown by way of examples in the drawings and will be described in detail below. It should be understood, however, that it is not intended to limit the disclosure to the particular form disclosed, but on the contrary, the disclosure is to cover all modifications, equivalents, and alternatives falling within the spirit and the scope of the disclosure.

The terms “comprise(s)”, “comprising”, “include(s)”, or any other variations thereof, are intended to cover a non-exclusive inclusion, such that a setup, device, apparatus, system, or method that comprises a list of components or steps does not include only those components or steps but may include other components or steps not expressly listed or inherent to such setup or device or apparatus or system or method. In other words, one or more elements in a device or system or apparatus preceded by “comprises . . . a” does not, without more constraints, preclude the existence of other elements or additional elements in the system.

In the present disclosure, the terms like “RAN communication system” “communication system” may be used interchangeably throughout the description. The terms like “C-plane message” and “C-plane command” may be used interchangeably throughout the description.

In the following detailed description of the embodiments of the disclosure, reference is made to the accompanying drawings that form a part hereof, and in which are shown by way of illustration of specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense. In the following description, well known functions or constructions are not described in detail since they would obscure the description with unnecessary detail.

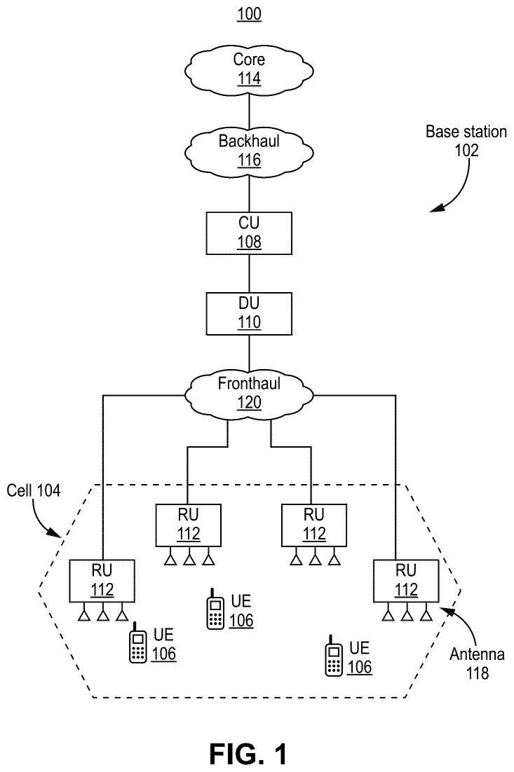

Referring now to FIG. 1 which shows a block diagram illustrating an exemplary radio access network (RAN) communication system 100 in which the techniques of the present disclosure may be implemented. The RAN communication system 100 may comprise a base station entity 102 which may serve a cell 104. The base station entity 102 may also be referred to as a “base station” or “base station system” (and, which in the context of a fourth generation (4G) Long Term Evolution (LTE) system, may also be referred to as an “evolved NodeB”, “eNodeB”, or “eNB” and, in the context of a fifth generation (5G) New Radio (NR) system, may also be referred to as a “gNodeB” or “gNB”).

The cell 104 may comprise at least one UE 106 and the base station 102 may be configured to provide wireless services to the at least one UE 106 served by the associated cell 104. The at least one UE 106 may be any mobile or non-mobile computing device including, but not limited to, a phone (e.g., a cellular phone or smart phone), a pager, a laptop computer, a desktop computer, a wireless handset, a portable communication device, a portable computing device (e.g., a personal data assistant), an entertainment device (e.g., a music or video device, or a satellite radio), a global positioning system device, or any other suitable computing device including a wired or wireless communications interface. In some embodiments of the present disclosure, the at least one UE 106 may be Internet-of-Things (IoT)-enabled device including, but not limited to, sensors, actuators, vehicles, and gateways therefor and can be embedded in other devices (for example, to implement so-called “smart” devices that can be remotely monitored or controlled using one or more wireless-connectivity enabled applications) and/or can be attached to or otherwise associated with devices that do not natively include the functionality implemented by the associated IoT devices (for example, in a so-called “retro-fit” application where an otherwise “dumb” device is made “smart” by attaching or otherwise associating the IoT device with the dumb device).

Unless explicitly stated to the contrary, references to Layer 1, Layer 2, Layer 3, and other or equivalent layers (such as the Physical Layer or the Media Access Control Layer) refer to layers of the particular wireless interface (for example, 4G LTE or 5G NR) used for wirelessly communicating with the at least one UE 106. Furthermore, it is also to be understood that the techniques of the present disclosure can be used in both standalone and non-standalone modes (or other modes developed in the future), and the following description is not intended to be limited to any particular mode. Moreover, although some embodiments are described here as being implemented for use with 5G wireless systems and interfaces, the following description is not intended to be limited to any particular wireless system or interface.

In one exemplary embodiment of FIG. 1, the RAN communication system 100 may be implemented using a centralized or cloud RAN (C-RAN) architecture in which the base station 102 is implemented as a 5G NR gNB 102. In this embodiment, the gNB 102 may be partitioned into a central unit (CU) 108, a distributed unit (DU) 110, and one or more radio units (RUs) 112. In such a configuration, the CU 108 may implement Layer 3 and non-time critical Layer 2 functions for the gNB 102. In this embodiment the CU 108 and the DU 110 are designed to run on or in “cloud” such that they can horizontally and vertically scale computing resources based on traffic demand.

In the embodiment of FIG. 1, the CU 108 may be further partitioned into a control-plane entity (CU-CP) and one or more user-plane entities (CU-UP) (not shown in FIG. 1) that may handle control-plane and user-plane processing of the CU 108, respectively. Also, in such a configuration, the DU 110 may be configured to implement time critical Layer 2 functions and at least some of the Layer 1 functions for the gNB 102. In such configuration, each RU 112 may be configured to implement the Radio Frequency (RF) interface, as well as physical layer functions for the gNB 102 that are not implemented in the DU 110. Also, each RU 112 may include or may be coupled to a respective set of one or more antennas 118 via which downlink RF signals are radiated to the UEs 106 and via which uplink RF signals transmitted by the UEs 106 are received.

In one implementation (as shown in FIG. 1), each RU 112 may be remotely located from the DU 110 serving it, e.g., the RUs 112 may be deployed at a cell site while the DU 110 may be located at a centralized location far from the RUs 112. Also, in such an implementation, at least one of the RUs 112 may be remotely located from at least one other RU 112 serving the associated cell 104. In another implementation, at least some of the RUs 112 may be co-located with each other, where the respective sets of antennas 118 associated with the RUs 112 are directed to transmit and receive signals from different areas.

Each RU 112 may be communicatively coupled to the DU 110 serving it via a fronthaul network 120 (also referred to as a “fronthaul interface 120”). The fronthaul network 120 may be implemented using switches, routers, and/or other networking devices. In one implementation, the fronthaul network 120 may be a switched Ethernet network, in that case each RU 112 and the DU 110 may include one or more Ethernet network interfaces to couple each RU 112 and the DU 110 to the fronthaul network 120 in order to facilitate communications between the DU 110 and the RUs 112. In one implementation, the Ethernet network interfaces may be used for communication between the DU 110 and the RUs 112 over the fronthaul network 120. In one implementation, an O-RAN fronthaul interface may be used for communication between the DU 110 and the RUs 112 over the fronthaul network 120 (where, “O-RAN” stands for Open Radio Access Network). In another implementation, a proprietary fronthaul interface is used that employs a so-called “functional split 7-2” for at least some of the physical channels (for example, for the PDSCH and PUSCH) and a different functional split for at last some of the other physical channels (for example, using a functional split 6 for the PRACH and SRS). It may be noted that the fronthaul interface 120 between each DU 110 and the RUs 112 served by it can be implemented in other ways.

In such an example, the CU 108 may be configured to communicate with a core network 114 of an associated wireless operator using an appropriate backhaul network 116 (typically, a public wide area network such as the Internet). In one non-limiting embodiment of the present disclosure, the core network 114 may be a 5G core network in a standalone mode of deployment. In another non-limiting embodiment, the core network 114 may be a long-term evolution evolved packet core (LTE EPC) network in a non-standalone mode of deployment where at least some services are provided using previous generation infrastructure (e.g., using existing LTE EPC). The present disclosure is applicable for standalone and/or non-standalone modes of deployments or other modes of deployments which may be developed in the future.

In some deployments, the RAN communication system 100 may be implemented in accordance with one or more public standards and specifications. For example, the RAN communication system 100 may be implemented using a RAN architecture and/or RAN fronthaul interfaces defined by the O-RAN Alliance in order to provide 4G LTE and/or 5G wireless services. In such an implementation of the RAN communication system 100, the DU 110 and RUs 112 may be implemented as O-RAN distributed units (O-DU) and O-RAN remote/radio units (O-RU), respectively, in accordance with the O-RAN specifications. However, the present disclosure is not limited thereto and, in general, the RAN communication system 100 may be implemented in other ways as well.

Although FIG. 1 (and the description set forth below more generally) is described in the context of a 5G architecture in which the base station 102 is partitioned into a CU 108, a DU 110, and at least one RU 112 and some physical-layer processing is performed in the DU 110 with the remaining physical-layer processing being performed in the RUs 112, it is to be understood that the techniques described here may be used with other wireless interfaces (for example, 4G LTE) and with other ways of implementing a base station entity (for example, using conventional baseband units (BBUs)/remote radio heads (RRHs) architecture, where the functionalities of CUs 108 and/or DUs 108 are implemented using the BBUs while the functionalities of RUs 112 are implemented using the RRHs). Accordingly, references to a CU, DU, or RU in this description and associated figures may also be considered to refer more generally to any entity (including, for example, any base station or RAN entity) implementing any of the functions or features described here as being implemented by a CU, DU, or RU.

Each CU 108, DU 110, RU 112 and any of the specific features described herein may be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory storage medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented the software. Such hardware or software (or portions thereof) can be implemented in other ways (for example, in an application specific integrated circuit (ASIC), etc.).

Moreover, each CU 108, DU 110, RU 112 may be implemented as a physical network function (PNF) (for example, using dedicated physical programmable devices and other circuitry) and/or a virtual network function (VNF) (for example, using one or more general purpose servers (possibly with hardware acceleration) in a scalable cloud environment and in different locations within an operator's network (for example, in the operator's “edge cloud” or “central cloud”). Each VNF can be implemented using hardware virtualization, operating system virtualization (also referred to as containerization), and application virtualization as well as various combinations of two or more the preceding. Where containerization is used to implement a VNF, it may also be referred to as a containerized network function (CNF).

For example, in the exemplary embodiment shown in FIG. 1, each RU 112 may be implemented as a PNF and may be deployed in or near a physical location where radio coverage is to be provided and the CU 108 and the DU 110 may be implemented using a respective set of one or more VNFs deployed in a distributed manner within one or more clouds (for example, within an “edge” cloud or “central” cloud). However, the present disclosure is not limited thereto, and each of CU 108, DU 110, RU 112, and any of the specific features described here as being implemented thereby, may be implemented in other ways.

In the exemplary embodiment of FIG. 1, for the sake of simplicity, it has been shown that the RAN communication system 100 comprises only one base station (gNB) 102, one CU 108, one DU 110, and one cell 104 served by one or more RUs 112. However, the present disclosure is not limited thereto and in general the RAN communication system 100 may comprise more than one base station (gNB) 102 connected with each other via an Xn interface. Each base station 102 may comprise more than one CU 108, more than one DU 110, more than one RU 112 serving more than one cell 104. In such configuration, the gNB 102 may elastically scale CUs 108 and/or DUs 110 based on a traffic load i.e., when the traffic load is higher, the gNB 102 may add more CUs and/or DUs.

In the exemplary embodiment described in connection with FIG. 1, each RU of the plurality of RUs 112 serving the cell 104 may include or may be coupled to a respective set of one or more antennas 118 via which downlink data may be transmitted from the gNB 102 to the UEs 106 of the cell 104 and via which uplink data from the UEs 106 may be received by the gNB 102. The gNB 102 may be configured to serve each UE of the cell 104 using a set of one or more RUs identified/selected from the plurality of RUs 112. Said differently, the gNB 102 may transmit data to a particular UE 106 of the cell 104 (in the downlink) and may receive data from the particular UE 106 (in the uplink) using a group of RUs selected from the plurality of RUs 112. Such selection of the one or more RUs for providing wireless services to the particular UE may be named as ‘user equipment localization’ or ‘UE localization’.

In an implementation, the gNB 102 may configure different groups of RUs for transmitting data to the particular UE 106 and receiving data from the particular UE 106. A group of RUs 112 configured by the gNB 102 to wirelessly transmit data to the particular UE 106 may be also referred to as a “simulcast zone” for the particular UE 106. Also, a group of RUs 112 can be configured by the gNB 102 to receive data wirelessly transmitted by the particular UE 106 (for example, using a combining receiver). The group of RUs 112 used by the gNB 102 to receive data wirelessly transmitted by the particular UE 106 is also referred to as a “combining zone” for the particular UE 106. Different UEs 106 can have different simulcast zones and combining zones. The corresponding fronthaul data transmitted to or received from the particular UE 106 must be communicated over the fronthaul network 120 between the DU 110 and each RU 112 in that UE's simulcast zone or combining zone. The size of a simulcast zone or combining zone refers to the number of RUs 112 that are included in that simulcast zone or combining zone. In general, the respective simulcast zone and combining zone for the particular UE 106 include those RUs 112 that have the best or strongest signal reception or transmission characteristics for the particular UE 106. For a UE 106, the simulcast zone and combining zone may be same or different. The simulcast and combining zones for a particular UE may change depending on one or more conditions/events (e.g., if there is change in network configuration (e.g., addition of new RUs within a cell, removal of RUs from the cell etc.)).

In one implementation, (e.g., when the fronthaul network 120 implements O-RAN compliant fronthaul interface), the RAN communication system 100 may be configured to use four different types of messages or communications, each of which is communicated in a separate logical plane. The messages communicated over the fronthaul network 120 can be categorized into: management-plane (M-plane) messages, control-plane (C-plane) messages (also referred to as “C-plane commands”), user-plane (U-plane) messages, and synchronization-plane (S-plane) messages. The U-plane messages are sent in each slot and are sent from the DU 110 to each RU 112 to provide the RU 112 with portions of user data to be transmitted from that RU during each slot. S-plane messages are exchanged between the DU 110 and each RU 112 in order to synchronize the DU 110 and RUs 112. M-plane messages comprise messages that pertain to the instantiation, configuration and management of the RUs 112. M-plane messages are communicated infrequently, typically during initial configuration and during system reconfigurations.

The C-plane messages or commands are sent in each TTI (generally, one TTI may comprise a certain number of slots depending on the RAN deployment). Downlink C-plane commands are sent from the DU 110 to each RU 112 to provide the RU with information regarding the configuration of user data included in associated U-plane messages for a given slot. The information carried by the downlink C-plane commands may include: information specifying which antenna port the associated portion of user data is intended for, a set of Physical Resource Blocks (PRBs) over which the associated portion of user data should be transmitted, a resource element (RE) mask to designate a subset of REs within each PRB for use with different beams transmitted during the same PRB, beamforming information, time-division duplexing (TDD) Information, etc.

A downlink C-plane command is transmitted using a set of dedicated time-frequency resources or PRBs allocated by the gNB 102. The C-plane commands in the downlink direction are typically transmitted using a specific Physical Downlink Control Channel (PDCCH). In one implementation, among other things, a downlink C-plane command may carry information specifying what resources (e.g., Physical Resource Blocks) to allocate to respective UE(s) for transmitting uplink data associated with the respective UE(s). The gNB 102 may be configured to schedule the plurality of UEs 106 across the plurality of RUs 112. In an aspect, “scheduling” may be defined as allocating resources to the UEs 106 for exchanging data with the gNB 102. Specifically, “scheduling” may refer to making decisions about which UEs to communicate with, what resources (e.g., PRBs) to allocate to the UEs for uplink communications, and when to allocate those resources. In order to schedule the plurality of UEs 106 across the plurality of RUs 112, the RAN communication system 100 may comprise a scheduler (e.g., for Layer-2 processing in the DU/CU or BBU). For each connected UE 106, the gNB 102 may generate at least one configuration message comprising scheduling information for the UE 106 (e.g., allocated physical resource blocks (PRBs), scheduled transmission time slot, etc.). The DU 110 (particularly the scheduler) may then generate a C-plane command corresponding to each configuration message and broadcast the generated C-plane command towards the plurality of RUs 112 served by the DU 110. The C-plane command is transmitted over a respective set of Physical Resource Blocks (PRBs). This process is repeated after every Transmission Time Interval (TTI) for each UE served by the plurality of RUs 112. Hence, for each TTI, the DU 110 is configured to transmit one C-plane command for each connected UE.

The gNB 102 may add additional data (e.g., bitmask) to each C-plane command (sent from the DU 110 to the RUs 112) indicating which RU(s) 112 the C-plane command is intended for. Upon receiving the C-plane commands from the DU 110, each RU 112 may be configured to decode the received C-plane commands and identify one or more C-plane commands which are intended for that RU 112. For instance, a RU 112 may utilize the additional information provided in a C-plane command to check if the C-plane command is intended for the RU 112 or not (i.e., whether the C-plane command comprises information associated with a UE served by the RU 112). Upon identifying that a given C-plane command is intended for the RU 112, the RU 112 may generate an analog radio frequency (RF) signal corresponding to the decoded C-plane command and transmit the analog RF signal over the air interface towards the UE served by the RU 112.

Likewise in the uplink direction, the RU 112 may generate one small size uplink data packet (also referred to as “IQ packet” or “IQ data packet” or “IQ data”) for each UE 106 served by the RU 112 (e.g., upon receiving respective uplink analog RF signals from the UEs served by the RU 112) and transmit the generated uplink IQ packet using the allocated resources (PRBs) specified in the scheduling information received in downlink C-plane command. The fronthaul network 120 receives the IQ packets from each RU per UE basis and forwards those IQ packets to the DU 110 for further processing. Since the uplink IQ packets are unicast from each RU 112 to the DU 110, the additional data (e.g., RU-id bitmasks) are not required for the uplink IQ packets. It may be noted that the uplink IQ packets are typically transmitted over a Physical Uplink Control Channel (PUCCH) or a Physical Uplink Shared Channel (PUSCH) or a Sounding Reference Signal (SRS) channel depending on the specific use case and each of these channels use the allocated Physical Resource Blocks (PRBs) for transmission of the uplink IQ packets.

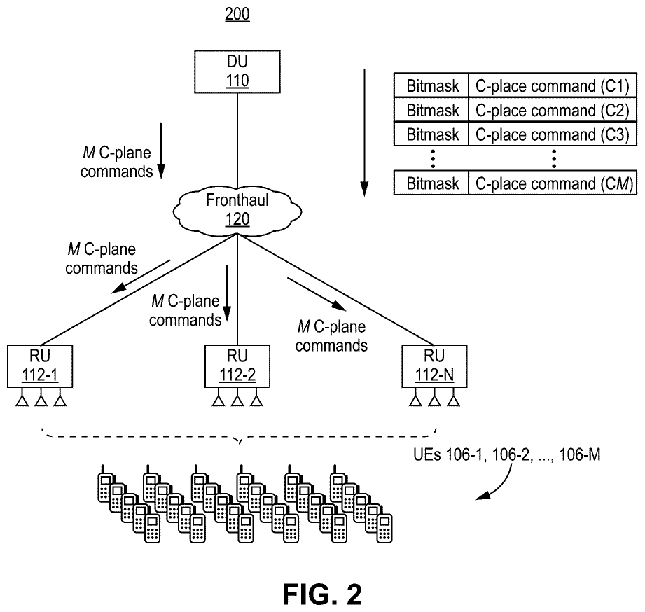

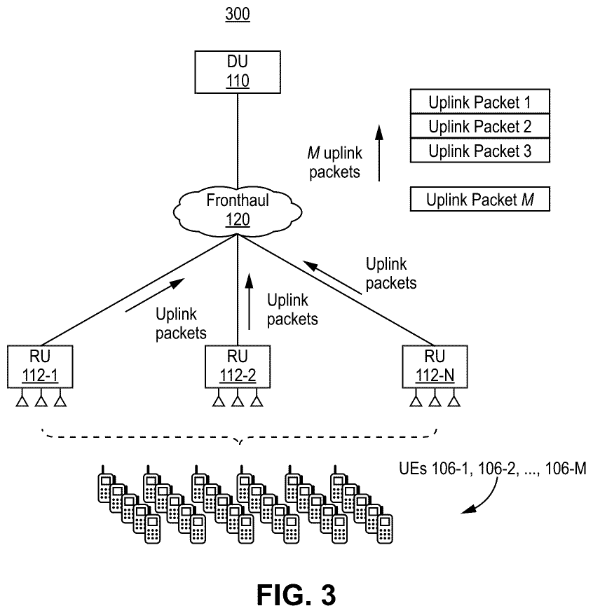

It may be worth noting that as the number of UEs increases in the RAN communication system 100, the number of downlink C-plane commands also increases because the DU 110 is generating one C-plane command per UE and consequently, uplink IQ packets transmitted from the RUs 112 towards DU 110 over the fronthaul network 120 would also increase. Thus, the DU 110 (specifically, Network Interface Controller(s) of the DU 110), the RUs 112, switches (access and aggregate switches) need to handle more small sized packets which may degrade the overall performance of the system. This may be understood using the exemplary RAN deployments as shown in FIGS. 2-3.

Referring now to FIG. 2, which shows an exemplary block diagram 200 of an exemplary RAN deployment showing transmissions of C-plane commands from a DU 110 towards a plurality of RUs 112-1, 112-2, . . . , 112-N (collectively referred to as “RUs 112”) over a fronthaul network 120. As shown in FIG. 2, the RUs 112 are configured to serve a plurality of user equipment (UEs) 106-1, 106-2, . . . , 106-M (collectively referred to as “UEs 106”). For the sake of simplicity, it is assumed here that each UE 106 is being served by a single RU 112. However, the present disclosure is not limited thereto and in general, one UE may be served using a group of RUs 112. In order to schedule the plurality of UEs 106-1 to 106-M across the plurality of RUs 112-1 to 112-N, the scheduler may generate M configuration messages spaced out in time domain within a given TTI (i.e., one configuration message for each UE). Among other things, each configuration message may comprise scheduling information for the respective UE and the scheduling information may specify what resources (e.g., PRBs) are allocated for transmitting uplink data associated with the respective UE. Parallelly, the DU 110 keeps generating C-plane commands corresponding to the generated configuration messages and broadcasts the generated C-plane commands spaced-out in time towards the RUs 112-1 to 112-N served by the DU 110, as shown in FIG. 2. This process is repeated after every Transmission Time Interval. Thus, within a given TTI, the DU 110 generates M downlink C-plane commands (C1, C2, . . . , CM) corresponding to the M configuration messages (i.e., one downlink C-plane command for each UE) and broadcasts the generated M downlink C-plane commands to all the RUs 112 via the fronthaul network 120.

Upon receiving the broadcasted M C-plane commands, each RU 112 may utilize the additional information (e.g., bitmask) included or appended in the C-plane commands to identify the C-plane command(s) that are intended for the RU 112. For instance, the RU 112 may decode each of the M C-plane commands and if the decoding indicates that the C-plane command is intended for the RU 112 (i.e., the C-plane command corresponds to a UE served by the RU 112), the RU 112 may generate an analog radio frequency (RF) signal corresponding to the intended C-plane command and transmit the analog RF signal over the air interface towards the respective UE served by the RU 112. In the uplink direction, the RU 112 may generate one small size uplink IQ packet corresponding to the C-plane command and transmit the generated uplink IQ packet towards the DU 110 over the allocated PRBs (specified in respective scheduling information received in the downlink C-plane command).

Consider that in the exemplary RAN deployment of FIGS. 2, N=3 and M=30 i.e., there are 3 RUs 112-1, 112-2, 112-3 which are configured to serve 30 UEs 106-1, . . . , 106-30 such that RU 112-1 is configured to serve 10 UEs 106-1 to 106-10; RU 112-2 is configured to serve UEs 106-11 to 106-20; and RU 112-3 is configured to serve UEs 106-21 to 106-30. The DU 110 broadcasts 30 downlink C-plane commands within a specified TTI, namely, C1-C30 spaced out in time domain to all the RUs 112 and each RU decodes all 30 C-plane commands. Consider that upon decoding the 30 commands, the RU 112-1 identifies that commands C1-C10 are intended for it (i.e., commands C1-C10 correspond to UEs 106-1 to 106-10 served by the RU 112-1), the RU 112-2 identifies that commands C11-C20 are intended for it (i.e., commands C11-C20 correspond to UEs 106-11 to 106-20); and the RU 112-3 identifies that commands C21-C30 are intended for it (i.e., commands C21-C30 correspond to UEs 106-21 to 106-30). For each intended C-plane command, an RU 112 may generate one small size uplink IQ packet and transmit the generated uplink IQ packet over the allocated PRBs, as shown in FIG. 3.

Referring now to FIG. 3 which shows an exemplary block diagram 300 of an exemplary RAN deployment showing transmissions of uplink IQ packets from the plurality of RUs 112 towards the DU 110 over the fronthaul network 120. As explained in connection with the exemplary implementation of FIG. 2, each RU 112 receives all M downlink C-plane commands spaced in time domain and may utilize the additional information provided in the C-plane commands to identify the C-plane command(s) that are intended for the RU 112. Consider that upon decoding the M C-plane commands, each RU 112 identifies that only few of the all M C-plane commands are intended for the RU 112. The RU 112 may then generate one small size IQ packet for each intended C-plane command and transmit the generated uplink IQ packet(s) over the fronthaul network 120 towards the DU 110. The fronthaul network 120 receives uplink IQ packets from each RU 120 per UE basis and forwards those IQ packets to the DU 110 for further processing. For M downlink C-plane commands, the fronthaul network 120 receives M small size uplink IQ packets (P1, P2, . . . , PM) from the plurality of RUs 112.

In the above exemplary deployment of 3 RUs and 30 UEs, RU 112-1 generates 10 small size IQ packets (P1-P10) spaced in time domain corresponding to the UEs 106-1 to 106-10, RU 112-2 generates 10 small size IQ packets (P11-P20) spaced in time domain corresponding to the UEs 106-11 to 106-20, and RU 112-3 generates 10 small size IQ packets (P21-P30) spaced in time domain corresponding to the UEs 106-21 to 106-30. The fronthaul network 120 forwards the 30 small size uplink IQ packets (P1-P30) received from the three RUs 112-1 to 112-3 towards the DU 110 for further processing.

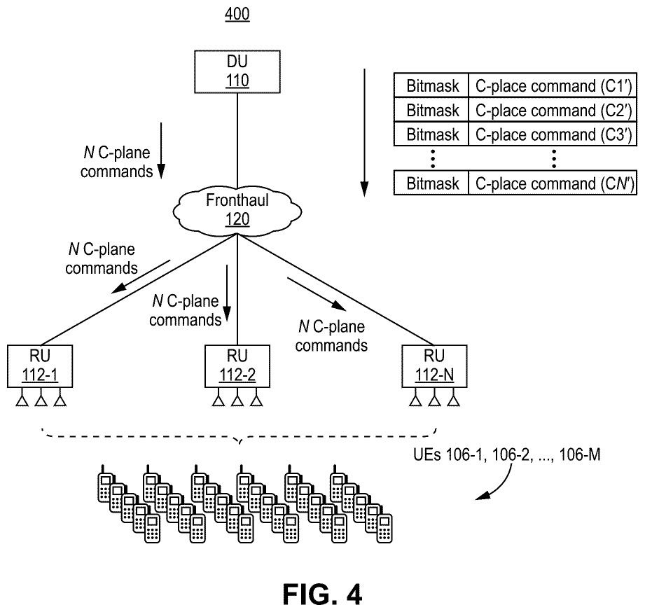

Thus, the DU 110, the RUs 112, and the fronthaul network 120 need to handle more small sized IQ packets (one small size IQ packet per UE) within a given TTI, which may degrade the overall performance of the RAN communication system 100. To overcome this and other related problems, the present disclosure discloses techniques of reducing the number of small sized IQ packets transmitted over the fronthaul network 120 within a given TTI. In the proposed techniques, instead of sending one C-plane command for each UE, the DU 110 is configured to generate and send one consolidated C-plane command per RU 112 over the fronthaul network 120, as shown in FIG. 4.

Referring now to FIG. 4, which shows an exemplary block diagram 400 of an exemplary RAN deployment showing transmissions of consolidated C-plane commands from the DU 110 towards the plurality of RUs 112 over the fronthaul network 120. In the exemplary RAN deployment of FIG. 4, the scheduler may generate at least one configuration message for each connected UE of the plurality of UEs 106, each configuration message comprises scheduling information for the respective UE. The DU 110 may then generate one C-plane command corresponding to each configuration message and add additional data to each C-plane command indicating which RU(s) 112 the C-plane command is intended for.

In some configurations, the additional data may be an indicator or a bitmask (also referred to as “an RU-id bitmask”), which is a set of bits (e.g., each having a value of “1” or “0”). The length of the RU-id bitmask may be equal to at least the number of RUs 112 served by the DU 110 in a given sector. The length of the RU-id bitmask may be configured during initial configuration of the C-RAN 100 and/or during reconfiguration of the C-RAN 100. Each RU 112 serving the given sector may be assigned a unique identifier (“RU-id”) which may be an integer between 0 and the number of RUs serving that sector (N) minus 1 (i.e., between 0 and N-1). Also, each RU 112 serving a given sector is assigned a particular bit position within the RU-id bitmask. This bit position within the RU-id bitmask may be referred to as an “RU-index.” A particular C-plane command (or the data described in a particular C-plane message or data communicated in one or more U-plane messages associated with the particular C-plane message) is intended for a given RU if the RU-index in the RU-id bitmask for that given RU has a value of “1” and is not intended for the given RU if the RU-index in the RU-id bitmask for that given RU has a value of “0”. The mapping of each RU to a particular RU-index in the RU-id bitmask can be configured via M-plane messages.

In the exemplary deployment of FIG. 4, instead of forwarding the C-plane commands spaced in time domain, the DU 110 may wait for a predefined time period (e.g., for a given TTI) and aggregate/consolidate C-plane commands per RU using the RU-id bitmask field and then transmit one consolidated C-plane command for each RU 112 over the fronthaul network 120. For instance, the DU 110 may analyze the RU-id bitmasks of all C-plane commands received during the predefined time period and consolidate C-plane commands per RU basis i.e., for a given RU, the DU 110 may consolidate all C-plane commands which are intended for the given RU to generate a single consolidated C-plane command for the given RU.

In one non-limiting embodiment, the DU 110 may append additional data (e.g., RU-id bitmask) with each of the consolidated C-plane commands to indicate the RU for which the consolidated C-plane command is intended. As discussed above, the gNB 102 allocates dedicated PRBs for each downlink C-plane command. The DU 110 may consolidate the PRBs of all C-plane commands which are received during the predefined time period to determine consolidated PRBs (i.e., a consolidated wide bandwidth comprising a plurality of PRBs) over which the consolidated C-plane commands are transmitted. At the end of the predefined time interval, the DU 110 generates N consolidated C-plane commands (C1′, C2′, . . . , CN′), one for each of the N RUs 112. The N C-plane commands are then simulcasted (simultaneously broadcasted) using the consolidated PRBs over the fronthaul network 120 towards all of the plurality of RUs 112, as shown in FIG. 4. Among other things, a consolidated C-plane command for a particular RU 112 may comprise scheduling information associated with all UEs 106 served by the particular RU 112. The scheduling information may indicate (combined) PRBs allocated for transmitting uplink data associated with all UEs served by the particular RU 112.

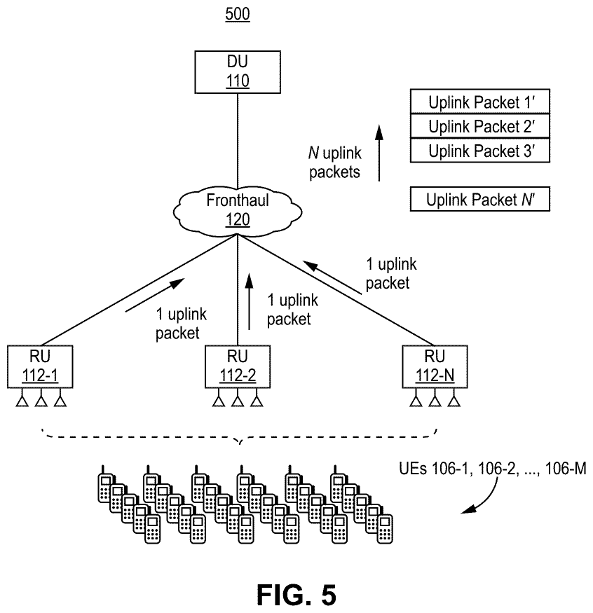

Upon receiving the simulcasted N consolidated C-plane commands, each RU 112 may utilize the additional information provided in the consolidated C-plane commands to identify the one consolidated C-plane command that is intended for that RU 112. For instance, the RU 112 may decode each of the N consolidated C-plane commands and if the decoding indicates that the C-plane command is intended for the RU 112 (i.e., the C-plane command corresponds to the UEs served by the RU 112), the RU 112 may generate downlink analog radio frequency (RF) signals based on the consolidated C-plane command and transmit the respective analog RF signals over the air interface towards the respective UEs served by the RU 112. In the uplink direction, the RU 112 may generate one large size or consolidated uplink IQ packet corresponding to the consolidated C-plane command and transmit the generated consolidated uplink IQ packet over the fronthaul network 120, as shown in FIG. 5.

In the above example, (where N=3, M=30, and each RU is serving only 10 UEs), the DU 110 generates only 3 downlink C-plane commands C1′, C2′, and C3′ i.e., one C-plane command for each RU. The C-plane command C1′ comprises data/scheduling information associated with all UEs 106-1 to 106-10 served by the RU 112-1; the C-plane command C2′ comprises data/scheduling information associated with all UEs 106-11 to 106-20 served by the RU 112-2; and the C-plane command C3′ comprises data/scheduling information associated with all UEs 106-21 to 106-30 served by the RU 112-3. All three C-plane commands are simulcasted towards all three RUs 112-1 to 112-3 and each RU 112 decodes the received C-plane commands to identify one C-plane command which is intended for the RU 112. Consider that upon decoding the 3 C-plane commands, the RU 112-1 identifies that commands C1′ is intended for it (i.e., commands C1′ comprises data/scheduling information corresponding to the UEs 106-1 to 106-10 served by the RU 112-1), RU 112-2 identifies that commands C2′ is intended for it (i.e., commands C2′ comprises data/scheduling information corresponding to the UEs 106-11 to 106-20 served by the RU 112-2), and RU 112-3 identifies that commands C3′ is intended for it (i.e., commands C3′ comprises data/scheduling information corresponding to the UEs 106-21 to 106-30 served by the RU 112-3). Each RU 112 may generate one large size or consolidated uplink IQ packet corresponding to the intended consolidated C-plane command and transmit the consolidated uplink IQ packet over the allocated resources as indicated by the scheduling information received in the consolidated downlink C-plane command, as shown in FIG. 5.

Referring now to FIG. 5 which shows an exemplary block diagram 500 of an exemplary RAN deployment showing transmissions of uplink IQ packets from a plurality of RUs 112 towards the DU 110 over the fronthaul network 120. As explained in connection with the exemplary implementation of FIG. 4, each RU 112 receives all N downlink C-plane commands and may utilize the ‘RU-id bitmask’ to identify the one C-plane command that is intended for the RU 112. The RU 112 may then generate one large size or consolidated IQ packet for the one intended command and transmit the generated large size uplink IQ packet over the fronthaul network 120 towards the DU 110. The fronthaul network 120 receives the consolidated IQ packets from each RU 120 per RU basis and forwards those IQ packets to the DU 110 for further processing. Here, the fronthaul network 120 receives N consolidated uplink IQ packets (P1′, P2′, . . . , PN'), one from each RU 120 and forwards those consolidated IQ packets to the DU 110.

In the above example, (where N=3, M=30, and each RU is serving only 10 UEs), each of the RUs 112-1 to 112-3 generate only one consolidated IQ packet corresponding to the UEs 106-1 to 106-10; UEs 106-11 to 106-20; and UEs 106-21 to 106-30 respectively. The fronthaul network 120 forwards the 3 large size uplink IQ packets received from the three RUs 112-1 to 112-3 towards the DU 110. Hence, instead of handling M small size IQ packets, the DU 110 needs to handle only N consolidated IQ packets (where N is less than M).

In this manner, in the downlink direction, one consolidated downlink C-plane command is transmitted per RU 112 which results in transmission of one consolidated IQ data packet per RU towards the DU 110. Hence, both downlink C-plane commands and corresponding uplink IQ data are transmitted on a per-RU basis instead of UE-by-UE basis. Due to such transmission of C-plane commands, the number of C-plane commands and hence the number of uplink IQ packets do not increase even when the number of UEs in the system increases.

It may be noted that the switches (e.g., access and aggregate switches in the RAN) may introduce transport latencies or network jitter depending on the size and quantity of IQ packets being transmitted. In general, it is better to handle transport latencies and network jitter with fewer larger packets instead of multiple small packets. When a switch receives multiple small packets, it needs to process and forward each packet individually, which can add additional processing overhead and delay. This can lead to increased network jitter and transport latencies, as well as potentially overloading the switch's buffer. On the other hand, sending fewer larger packets can reduce the number of packets that need to be processed and forwarded, which may help in reducing overall processing overhead and delay. Additionally, larger packets can be more efficiently buffered, as they require less memory and overhead than a larger number of smaller packets. Therefore, the techniques of the present disclosure use larger IQ packets to minimize the impact of switch processing overhead and buffer limitations and to improve the overall network performance.

In the present disclosure, the gNB 102 may be configured to use “frequency reuse.” “Downlink frequency reuse” refers to situations where separate downlink user data intended for different UEs 106 is simultaneously wirelessly transmitted to the UEs 106 using the same physical resource blocks (PRBs) for the same cell 104. Likewise, “uplink frequency reuse” refers to situations where separate uplink user data is simultaneously wirelessly transmitted from different UEs 106 using the same PRBs for the same cell 104. Generally, for those PRBs where downlink or uplink frequency reuse is used, the respective simulcast zone or the combining zone for the multiple UEs 106 that are “in reuse together” have no RUs 112 in common. Typically, frequency reuse can be used when the UEs 106 in reuse together are sufficiently physically separated from each other so that the co-channel interference resulting from the different simultaneous wireless transmissions is sufficiently low (that is, where there is sufficient RF isolation).

In the embodiments discussed in connection with FIGS. 2-5, the techniques of data transmission over the fronthaul network 120 are described as being implemented by a multi-RU gNB 102 of the type described above in connection with FIG. 1. More specifically, some operations of FIGS. 2-5 may be performed by the RUs 112 and some operations may be performed by the DU 110 of the gNB 102. In one non-limiting embodiment, the above-discussed techniques may be implemented for TDD special slot transmissions, which may repeat after every 5 ms or 10 slots for 30 kHz subcarrier spacing.

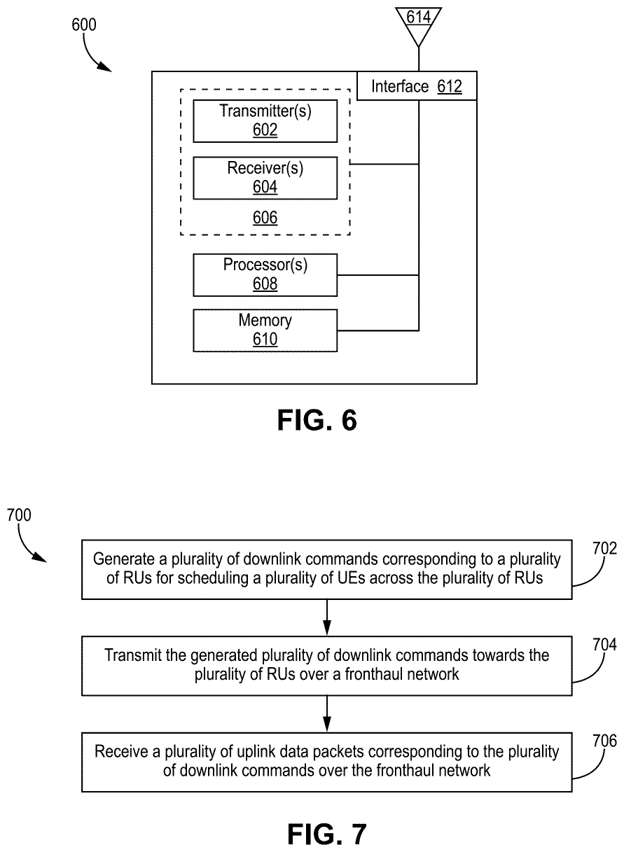

Referring now to FIG. 6, which shows a high-level block diagram of an apparatus 600 where the techniques consistent with the present disclosure may be implemented, in accordance with some embodiments of the present disclosure. In one non-limiting embodiment, the apparatus 600 may be used to perform functions of any of: the base station (gNB) or the base station system 102, a part of the base station 102 (e.g., the CU 108, the DU 110, the RU 112, or any other equivalent entity e.g., BBU, RRH), but not limited thereto.

The apparatus 600 may comprise at least one transmitter 602, at least one receiver 604, at least one processor 608, at least one memory 610, at least one interface 612, and at least one antenna 614. The at least one transmitter 602 may be configured to transmit data/information to one or more nodes/devices using the antenna 614 and the at least one receiver 604 may be configured to receive data/information from the one or more nodes/devices using the antenna 614. The at least one transmitter and receiver may be collectively implemented as a single transceiver module 606. In one non-limiting embodiment, the at least one processor 608 may be communicatively coupled with the transceiver 606, memory 610, interface 612, and antenna 614 for implementing the above-described techniques.

The at least one processor 608 may include, but not restricted to, microprocessors, microcomputers, micro-controllers, central processing units, state machines, logic circuitries, and/or any devices that manipulate signals based on operational instructions. A processor may also be implemented as a combination of computing devices, e.g., a combination of a plurality of microprocessors or any other such configuration. The at least one memory 610 may be communicatively coupled to the at least one processor 608 and may comprise various instructions, information related to allocation of resources to various entities of the system 100, RU-id bitmasks, etc. The at least one memory 610 may include a Random-Access Memory (RAM) unit and/or a non-volatile memory unit such as a Read Only Memory (ROM), optical disc drive, magnetic disc drive, flash memory, Electrically Erasable Read Only Memory (EEPROM), a memory space on a server or cloud and so forth. The at least one processor 608 may be configured to execute one or more instructions stored in the memory 610.

The interfaces 612 may include a variety of software and hardware interfaces, for example, a web interface, a graphical user interface, an input device-output device (I/O) interface, a network interface and the like. The I/O interfaces may allow the apparatus 600 to communicate with one or more nodes/devices either directly or through other devices. The network interface may allow the apparatus 600 to interact with one or more networks either directly or via any other network.

Referring now to FIG. 7 which illustrates an exemplary method of data transmission in a base station system, according to various embodiments of the present disclosure. The method described in FIG. 7 may be performed using a base station system 102 comprising a baseband unit (BBU) configured to perform at least some baseband processing, and a plurality of radio units (RUs) 112 communicatively coupled with the BBU over a fronthaul network 120 and configured to wirelessly communicate with a plurality of user equipment (UEs) 106 via a respective set of one or more antennas 118. In particular, the method described in FIG. 7 may be performed by the BBU which may comprise the DU 110.

The method 700 may include, at block 702, generating a plurality of (consolidated) downlink commands corresponding to the plurality of RUs 112 for scheduling the plurality of UEs 106 across the plurality of RUs 112. For example, the base station system or the gNB 102 may be configured to generate the plurality of downlink commands corresponding to the plurality of RUs 112 for scheduling the plurality of UEs 106 across the plurality of RUs 112.

In one non-limiting embodiment, the step of generating the plurality of downlink commands may comprise generating a single consolidated downlink command per RU of the plurality of RUs 112. For example, the base station system or gNB 102 may be configured to generate the single consolidated downlink command per RU of the plurality of RUs 112. Each of the plurality of downlink commands being a control plane (C-plane) command comprising information related to allocation of radio resources to all UEs served by a respective RU.

In one non-limiting embodiment, generating the single downlink command per RU may comprise receiving a plurality of (unconsolidated) downlink commands within a predefined time period, each received downlink command comprising a bitmask indicating one or more RUs for which the downlink command is intended. The generating the single downlink command per RU may further comprise identifying all received downlink commands that are intended for the RU by analyzing the respective bitmasks of the plurality of received downlink commands and generating the single downlink command for the RU by consolidating the identified downlink commands intended for the RU.

At block 704, the method 700 may include transmitting the generated plurality of downlink commands towards the plurality of RUs 112 over the fronthaul network 120. For example, the base station system or gNB 102 may be configured to transmit the generated plurality of downlink commands towards the plurality of RUs 112 over the fronthaul network 120.

In one non-limiting embodiment, the operation of block 702 i.e., transmitting the generated plurality of downlink commands towards the plurality of RUs 112 may comprise simulcasting the generated plurality of downlink commands over the fronthaul network 120. In one non-limiting embodiment, each of the plurality of downlink commands is simulcasted/transmitted over a consolidated bandwidth comprising a plurality of physical resource blocks.

At block 706, the method 700 may include receiving a plurality of uplink data packets corresponding to the plurality of downlink commands over the fronthaul network 120. For example, the base station system or gNB 102 may be configured to receive the plurality of uplink data packets corresponding to the plurality of downlink commands over the fronthaul network 120. In one non-limiting embodiment, receiving the plurality of uplink data packets comprises receiving a single uplink data packet per RU comprising data associated with all UEs served by the RU.

In one non-limiting embodiment, each RU of the plurality of RUs 112 is configured to serve one or more UEs of the plurality of UEs 106. In one aspect, the one or more UEs served by the RU are different from one or more UEs served by another RU of the plurality of RUs 112. In another aspect, at least one UE of the one or more UEs served by the RU is same as at least one UE of one or more UEs served by another RU of the plurality of RUs 112.

In one non-limiting embodiment, the BBU is configured to operate in a 4^{th} Generation (4G) Long Term Evolution (LTE) communication system. In another one non-limiting embodiment, the BBU may comprise at least one distributed unit (DU) 110 configured to operate in a Fifth Generation (5G) communication system.

The above method 700 may be described in the general context of computer executable instructions. Generally, computer executable instructions can include routines, programs, objects, components, data structures, procedures, modules, and functions, which perform specific functions or implement specific abstract data types. The various blocks of the method 700 shown in FIG. 7 have been arranged in a generally sequential manner for ease of explanation. However, it is to be understood that this arrangement is merely exemplary, and it should be recognized that the processing associated with method 700 (and the blocks shown in FIG. 7) may occur in a different order (for example, where at least some of the processing associated with the blocks is performed in parallel and/or in an event-driven manner). Additionally, individual blocks may be deleted from the methods without departing from the spirit and scope of the subject matter described herein. Furthermore, the methods can be implemented in any suitable hardware, software, firmware, or combination thereof.

The various operations of methods described above may be performed by any suitable means capable of performing the corresponding functions. The means may include various hardware and/or software component(s) and/or module(s). Generally, where there are operations illustrated in Figures, those operations may have corresponding counterpart means-plus-function components.

It may be noted here that the subject matter of some or all embodiments described with reference to FIGS. 2-5 may be relevant for the methods and the same is not repeated for the sake of brevity.

In a non-limiting embodiment of the present disclosure, one or more non-transitory computer-readable media may be utilized for implementing the embodiments consistent with the present disclosure. Certain non-limiting embodiments may comprise a computer program product for performing the operations presented herein. For example, such a computer program product may comprise a computer readable media having instructions stored (and/or encoded) thereon, the instructions being executable by one or more processors to perform the operations described herein. For certain non-limiting embodiments, the computer program product may include packaging material.

The terms “connected”, “coupled”, and “communicatively coupled” and related terms may refer to direct or indirect connections. The phrase “based on” does not mean “based only on,” unless expressly specified otherwise. In other words, the phrase “based on” describes both “based only on” and “based at least on”. As used herein, a phrase referring to “at least one” or “one or more” of a list of items refers to any combination of those items, including single members. As an example, “at least one of: A, B, or C” is intended to cover: A, B, C, A-B, A-C, B-C, and A-B-C. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the disclosed methods and systems.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limiting, of the scope of the disclosure, which is set forth in the appended claims.

### EXAMPLE EMBODIMENTS

Example 1 includes a method of data transmission in a base station system comprising a baseband unit (BBU) configured to perform at least some baseband processing, and a plurality of radio units (RUs) communicatively coupled with the BBU over a fronthaul network and configured to wirelessly communicate with a plurality of user equipment (UEs) via a respective set of one or more antennas, the method comprising: generating a plurality of downlink commands corresponding to the plurality of RUs for scheduling the plurality of UEs across the plurality of RUs, wherein generating the plurality of downlink commands comprises generating a single downlink command per RU of the plurality of RUs; transmitting the generated plurality of downlink commands towards the plurality of RUs over the fronthaul network; and receiving a plurality of uplink data packets corresponding to the plurality of downlink commands over the fronthaul network, wherein receiving the plurality of uplink data packets comprises receiving a single uplink data packet per RU comprising data associated with all UEs served by the RU.

Example 2 includes the method of Example 1, wherein generating the single downlink command per RU comprises: receiving a plurality of downlink commands within a predefined time period, each received downlink command comprising a bitmask indicating one or more RUs for which the downlink command is intended; identifying all received downlink commands that are intended for the RU by analyzing the respective bitmasks of the plurality of received downlink commands; and generating the single downlink command for the RU by consolidating the identified downlink commands intended for the RU.

Example 3 includes the method of any of Examples 1-2, wherein each of the plurality of downlink commands is a control plane (C-plane) command comprising information related to allocation of radio resources to UEs served by a respective RU.

Example 4 includes the method of any of Examples 1-3, wherein transmitting the generated plurality of downlink commands towards the plurality of RUs comprises simulcasting the generated plurality of downlink commands over a consolidated bandwidth comprising a plurality of physical resource blocks.

Example 5 includes the method of any of Examples 1-4, wherein each RU of the plurality of RUs is configured to serve one or more UEs of the plurality of UEs, and wherein the one or more UEs served by the RU are different from one or more UEs served by another RU of the plurality of RUs.

Example 6 includes the method of any of Examples 1-5, wherein each RU of the plurality of RUs is configured to serve one or more UEs of the plurality of UEs, and wherein at least one UE of the one or more UEs served by the RU is same as at least one UE of one or more UEs served by another RU of the plurality of RUs.

Example 7 includes the method of any of Examples 1-6, wherein the BBU is configured to operate in a 4th Generation (4G) Long Term Evolution (LTE) communication system.

Example 8 includes the method of any of Examples 1-7, wherein the BBU comprises at least one distributed unit (DU) configured to operate in a Fifth Generation (5G) communication system.

Example 9 includes a base station system comprising: a baseband unit (BBU) configured to perform at least some baseband processing; and a plurality of radio units (RUs) communicatively coupled with the BBU over a fronthaul network and configured to wirelessly communicate with a plurality of user equipment (UEs) via a respective set of one or more antennas, wherein the base station system is configured to: generate a plurality of downlink commands corresponding to the plurality of RUs for scheduling the plurality of UEs across the plurality of RUs, wherein to generate the plurality of downlink commands, the base station system is configured to generate a single downlink command per RU of the plurality of RUs; transmit the generated plurality of downlink commands towards the plurality of RUs over the fronthaul network; and receive a plurality of uplink data packets corresponding to the plurality of downlink commands over the fronthaul network, wherein to receive the plurality of uplink data packets, the base station system is configured to receive a single uplink data packet per RU comprising data associated with all UEs served by the RU.

Example 10 includes the base station system of Example 9, wherein to generate the single downlink command per RU, the base station system is configured to receive a plurality of downlink commands within a predefined time period, each received downlink command comprising a bitmask indicating one or more RUs for which the downlink command is intended; identify all received downlink commands that are intended for the RU by analyzing the respective bitmasks of the plurality of received downlink commands; and generate the single downlink command for the RU by consolidating the identified downlink commands intended for the RU.

Example 11 includes the base station system of any of Examples 9-10, wherein each of the plurality of downlink commands is a control plane (C-plane) command comprising information related to allocation of radio resources to UEs served by a respective RU.

Example 12 includes the base station system of any of Examples 9-11, wherein to transmit the generated plurality of downlink commands towards the plurality of RUs, the base station system is configured to simulcast the generated plurality of downlink commands over a consolidated bandwidth comprising a plurality of physical resource blocks.

Example 13 includes the base station system of any of Examples 9-12, wherein each RU of the plurality of RUs is configured to serve one or more UEs of the plurality of UEs, and wherein the one or more UEs served by the RU are different from one or more UEs served by another RU of the plurality of RUs.

Example 14 includes the base station system of any of Examples 9-13, wherein each RU of the plurality of RUs is configured to serve one or more UEs of the plurality of UEs, and wherein at least one UE of the one or more UEs served by the RU is same as at least one UE of one or more UEs served by another RU of the plurality of RUs.

Example 15 includes the base station system of any of Examples 9-14, wherein the BBU is configured to operate in a 4th Generation (4G) Long Term Evolution (LTE) communication system.

Example 16 includes the base station system of any of Examples 9-15, wherein the BBU comprises at least one distributed unit (DU) configured to operate in a Fifth Generation (5G) communication system.

Example 17 includes a non-transitory computer readable media for data transmission in a base station system comprising a baseband unit (BBU) configured to perform at least some baseband processing, and a plurality of radio units (RUs) communicatively coupled with the BBU and configured to wirelessly communicate with a plurality of user equipment (UEs) via a respective set of one or more antennas, wherein the non-transitory computer readable media stores one or more instructions which, when executed by the base station system, cause the system to: generate a plurality of downlink commands corresponding to the plurality of RUs for scheduling the plurality of UEs across the plurality of RUs, wherein generating the plurality of downlink commands comprises generating a single downlink command per RU of the plurality of RUs; transmit the generated plurality of downlink commands towards the plurality of RUs over the fronthaul network; and receive a plurality of uplink data packets corresponding to the plurality of downlink commands over the fronthaul network, wherein receiving the plurality of uplink data packets comprises receiving a single uplink data packet per RU comprising data associated with all UEs served by the RU.

What is claimed is:

1. A method of data transmission in a base station system comprising a baseband unit (BBU) configured to perform at least some baseband processing, and a plurality of radio units (RUs) communicatively coupled with the BBU over a fronthaul network and configured to wirelessly communicate with a plurality of user equipment (UEs) via a respective set of one or more antennas, the method comprising:
generating a plurality of downlink commands corresponding to the plurality of RUs for scheduling the plurality of UEs across the plurality of RUs, wherein generating the plurality of downlink commands comprises generating a single downlink command per RU of the plurality of RUs;
transmitting the generated plurality of downlink commands towards the plurality of RUs over the fronthaul network; and
receiving a plurality of uplink data packets corresponding to the plurality of downlink commands over the fronthaul network, wherein receiving the plurality of uplink data packets comprises receiving a single uplink data packet per RU comprising data associated with all UEs served by the RU.

2. The method of claim 1, wherein generating the single downlink command per RU comprises:
receiving a plurality of downlink commands within a predefined time period, each received downlink command comprising a bitmask indicating one or more RUs for which the downlink command is intended;
identifying all received downlink commands that are intended for the RU by analyzing the respective bitmasks of the plurality of received downlink commands; and
generating the single downlink command for the RU by consolidating the identified downlink commands intended for the RU.

3. The method of claim 1, wherein each of the plurality of downlink commands is a control plane (C-plane) command comprising information related to allocation of radio resources to UEs served by a respective RU.

4. The method of claim 1, wherein transmitting the generated plurality of downlink commands towards the plurality of RUs comprises simulcasting the generated plurality of downlink commands over a consolidated bandwidth comprising a plurality of physical resource blocks.

5. The method of claim 1, wherein each RU of the plurality of RUs is configured to serve one or more UEs of the plurality of UEs, and wherein the one or more UEs served by the RU are different from one or more UEs served by another RU of the plurality of RUs.

6. The method of claim 1, wherein each RU of the plurality of RUs is configured to serve one or more UEs of the plurality of UEs, and wherein at least one UE of the one or more UEs served by the RU is same as at least one UE of one or more UEs served by another RU of the plurality of RUs.

7. The method of claim 1, wherein the BBU is configured to operate in a 4^{th} Generation (4G) Long Term Evolution (LTE) communication system.

8. The method of claim 1, wherein the BBU comprises at least one distributed unit (DU) configured to operate in a Fifth Generation (5G) communication system.

9. A base station system comprising:
a baseband unit (BBU) configured to perform at least some baseband processing; and
a plurality of radio units (RUs) communicatively coupled with the BBU over a fronthaul network and configured to wirelessly communicate with a plurality of user equipment (UEs) via a respective set of one or more antennas, wherein the base station system is configured to:
generate a plurality of downlink commands corresponding to the plurality of RUs for scheduling the plurality of UEs across the plurality of RUs, wherein to generate the plurality of downlink commands, the base station system is configured to generate a single downlink command per RU of the plurality of RUs;
transmit the generated plurality of downlink commands towards the plurality of RUs over the fronthaul network; and
receive a plurality of uplink data packets corresponding to the plurality of downlink commands over the fronthaul network, wherein to receive the plurality of uplink data packets, the base station system is configured to receive a single uplink data packet per RU comprising data associated with all UEs served by the RU.

10. The base station system of claim 9, wherein to generate the single downlink command per RU, the base station system is configured to
receive a plurality of downlink commands within a predefined time period, each received downlink command comprising a bitmask indicating one or more RUs for which the downlink command is intended;
identify all received downlink commands that are intended for the RU by analyzing the respective bitmasks of the plurality of received downlink commands; and
generate the single downlink command for the RU by consolidating the identified downlink commands intended for the RU.

11. The base station system of claim 9, wherein each of the plurality of downlink commands is a control plane (C-plane) command comprising information related to allocation of radio resources to UEs served by a respective RU.

12. The base station system of claim 9, wherein to transmit the generated plurality of downlink commands towards the plurality of RUs, the base station system is configured to simulcast the generated plurality of downlink commands over a consolidated bandwidth comprising a plurality of physical resource blocks.

13. The base station system of claim 9, wherein each RU of the plurality of RUs is configured to serve one or more UEs of the plurality of UEs, and wherein the one or more UEs served by the RU are different from one or more UEs served by another RU of the plurality of RUs.

14. The base station system of claim 9, wherein each RU of the plurality of RUs is configured to serve one or more UEs of the plurality of UEs, and wherein at least one UE of the one or more UEs served by the RU is same as at least one UE of one or more UEs served by another RU of the plurality of RUs.

15. The base station system of claim 9, wherein the BBU is configured to operate in a 4^{th} Generation (4G) Long Term Evolution (LTE) communication system.

16. The base station system of claim 9, wherein the BBU comprises at least one distributed unit (DU) configured to operate in a Fifth Generation (5G) communication system.

17. A non-transitory computer readable media for data transmission in a base station system comprising a baseband unit (BBU) configured to perform at least some baseband processing, and a plurality of radio units (RUs) communicatively coupled with the BBU and configured to wirelessly communicate with a plurality of user equipment (UEs) via a respective set of one or more antennas, wherein the non-transitory computer readable media stores one or more instructions which, when executed by the base station system, cause the system to:
generate a plurality of downlink commands corresponding to the plurality of RUs for scheduling the plurality of UEs across the plurality of RUs, wherein generating the plurality of downlink commands comprises generating a single downlink command per RU of the plurality of RUs;
transmit the generated plurality of downlink commands towards the plurality of RUs over the fronthaul network; and
receive a plurality of uplink data packets corresponding to the plurality of downlink commands over the fronthaul network, wherein receiving the plurality of uplink data packets comprises receiving a single uplink data packet per RU comprising data associated with all UEs served by the RU.
